(19) United States
(12) Patent Application Publication
(10) Pub. No.: US 2014/0005892 A1
(43) Pub. Date: Jan. 2, 2014

(54) METHOD FOR CROSSWIND STABILIZATION OF A MOTOR VEHICLE

(71) Applicant: Audi AG, (US)

(72) Inventors: MICHAEL BÄR, Ingolstadt (DE); MICHAEL WEGSCHEIDER, Wettstetten (DE)

(73) Assignee: Audi AG, Ingolstadt (DE)

(21) Appl. No.: 13/713,696

(22) Filed: Dec. 13, 2012

(30) Foreign Application Priority Data
Dec. 14, 2011 (DE) 10 2011 121 117.2

(51) Int. Cl. B62D 9/00

(52) U.S. Cl. CPC B62D 9/002
USPC 701/41

(57) ABSTRACT

In a method for crosswind stabilization of a motor vehicle which includes front and rear wheels which are driven via an actively controllable differential with variable torque distribution and a device for detecting a lateral offset, a yaw moment is generated via the differential by changing the torque distribution when a lateral offset is detected, which yaw moment counteracts the lateral offset.

### CROSS-REFERENCES TO RELATED APPLICATIONS

This application claims the priority of German Patent Application, Serial No. 10 2011 121 117.2, filed Dec. 14, 2011, pursuant to 35 U.S.C. 119(a)-(d), the disclosure of which is incorporated herein by reference.

### BACKGROUND OF THE INVENTION

The present invention relates to a method for crosswind stabilization of a motor vehicle.

The following discussion of related art is provided to assist the reader in understanding the advantages of the invention, and is not to be construed as an admission that this related art is prior art to this invention.

Even though motor vehicles have a very high straight-running stability due to modern chassis engineering, strong crosswinds can lead to a drift i.e., the vehicle drifts sideways from the straight driving course due to the cross wind. This lane deviation is referred to as lateral offset. Such crosswinds often occur on exposed routes, on bridges or during takeover maneuvers in particular of trucks.

Modern vehicles have a device for detecting a lateral offset which enables qualitatively and quantitatively detecting a possible deviation from the lane as defined by the steering angle. With this, a crosswind-dependent lateral offset can also be determined. In order to stabilize the vehicle in such a situation, it is known to generate a yaw moment via a steering or braking intervention i.e., to guide the vehicle back via such a steering or braking intervention. As an alternative to this it is also known to tension the vehicle body for generating the yaw moment. In the known stabilizing options however, the vehicle sometimes reacts sluggishly, i.e. the stabilizing occurs slowly or with a lag. A lateral offset occurs in spite of the correction or the intervention.

It would therefore be desirable and advantageous to provide an improved method for crosswind stabilization which enables a fast and comprehensive correction of a crosswind offset.

### SUMMARY OF THE INVENTION

For crosswind stabilization, the method according to the invention provides for changing the torque distribution at the driven wheels. Such a variation of the torque distribution can be realized easily and over a wide range via an actively controllable differential, often also referred to as axle drive. A differential-dependent variation of the torque distribution is also often referred to as torque vectoring. This is a targeted distribution of drive torques which allows improving the driving dynamics. This purpose is served by an infinitely variable differential which is known for example from DE 10 2009 013 294 A1.

When a lateral offset or the start of a sideward drifting is detected by means of a suitable detection device, the distribution of the drive torques can be changed via the differential, so that as a result an active yaw moment builds up which counteracts the sideways drifting. According to the invention, the limited-slip-differential is thus not blocked for the crosswind stabilization, but is actively controlled in order to distribute the torque so as to effect a counter yaw moment via which the vehicle is guided back or via which an impending lateral offset is directly corrected, i.e., that an actively controllable differential i.e., a limited-slip-differential as it is known from DE 10 2009 013 294 A1 is not blocked in the case of sudden crosswinds (as it is known from DE 0 2009 013 294). Rather, the differential is used as active correction element for the crosswind stabilization and is actively controlled for the torque variation.

This means that according to the invention, the differential serves a further function, namely that of a crosswind stabilization element which allows implementation of a crosswind assist system in a simple manner. As a result, components for realizing an electronic steering for providing a yaw moment via the steering intervention are not required.

The lateral offset can be detected in different ways. According to a first embodiment, the lateral offset can be determined by means of a yaw sensor. Such a yaw sensor is often already installed in the vehicle, for example as part of an ESP-system (ESP=Electronic Stabilizing System). The yaw sensor detects a rotational movement about the vertical axis, from which the lateral offset can be determined compared to the setting of the steering wheel.

As an alternative or in addition, the lateral offset can also be detected by way of the rotational speed of the vehicle wheels. When the vehicle deviates for example from the straight driving line, i.e. it drives quasi a curve with an extremely great radius, a small difference in rotational speed results between wheels at the outside of the curve and wheels at the inside of the curve. From this, a possible lateral offset can also be determined. This type of lateral offset detection can be performed as an alternative or in addition to the yaw rate detection; the two detection methods can also be compared to each other for plausibility purposes.

A third alternative or additional possibility, for detecting the lateral offset is that the lateral offset is detected by way of images which are recorded by a camera and show the area in front of the vehicle. Modern motor vehicles often have driver assist systems which include a camera which records the area in front of the vehicle. In the area in front of the vehicle, lane markings or other construction or environmental conditions are usually present which, in particular in connection with the known steering angle which is set via the steering wheel, enable the detection of the lateral offset. Other detection means, for example in the form of radar sensors or lasers, can be used.

All items of information which describe a possible lateral offset, converge in a control device, or are optionally already detected in the control device, which also controls the differential. The control device determines corresponding control signals which describe the change of the torque distribution in order to quickly and directly counteract and thereby correct, the lateral offset. The change of the torque distribution can occur in dependence on the continuously determined lateral offset, i.e., the offset is continuously detected, and hence the success of the correction continuously verified. Thus, an open loop control of the torque distribution occurs.

As an alternative to a continuous detection and an open loop control in direct dependence on the detected lateral offset, it is conceivable in case of a required change of the torque distribution to first carry out a predetermined torque change, which can be readjusted if needed. Here, a direct basic change of a defined magnitude is provided when detecting a torque distribution, wherein after carrying out the change the success of the correction is verified. If the correction is sufficiently successful, no further change is performed. If the correction is not sufficiently successful, a readjustment is performed depending on the situation. For example, a basic adjustment can include to provide and additional torque of for example 100 Nm at one wheel or at two wheels which are located at the same side, which adjustment can be itself corrected depending on the success of the correction.

Beside the method, the invention also relates to a motor vehicle including front and rear wheels, wherein the front and/or rear wheels are driven via a differential with variable torque distribution which can be actively controlled by a control device, and a device for detecting a lateral offset. The motor vehicle according to the invention is characterized in that when detecting a lateral offset, a yaw moment which counteracts the lateral offset can be generated via the differential by changing the torque distribution. This means that the device for lateral offset detection which detects a drift which results from a crosswind, communicates with the control device of the differential so that a possible lateral offset can be immediately responded to by differential intervention.

The detection device can be a yaw sensor or can include a yaw sensor. Via the yaw sensor a yaw rate i.e., a rotation about the vertical axis is thus detected relative to the desired trajectory.

As an alternative or in addition, the detection device can be configured for detecting a lateral offset by way of the rotational speed of the vehicle wheels. Modern motor vehicles already provide for a detection of the rotational speed of the wheels, at least of the driven wheels. These parameters are for example required within the context of ESP-systems or for determining the driving speed. These parameters are then used in the motor vehicle according to the invention or also for detecting a possible lateral offset.

Finally, the detection device can also be a camera or include a camera, wherein the images of the camera show the area on front of the vehicle and a lateral offset is detected by analyzing the images of the camera.

According to a first embodiment, the control device can be configured for continuously changing the torque distribution in dependence on the continuous detection of the lateral offset. In this case, an open loop control of the torque is thus provided which, depending on the actually detected lateral offset, applies a directly corresponding corrective torque.

As an alternative to this, the control device can be configured for first changing the torque by always a same predetermined degree when a change of the torque distribution is required, and for readjusting if needed. Thus, a quasi two-step torque variation is provided, namely an initial change by a base torque when a lateral offset is detected in order to be able to immediately react. The success of the correction is verified, wherein depending on whether the correction was successful a readjustment is possible if needed.

### BRIEF DESCRIPTION OF THE DRAWING

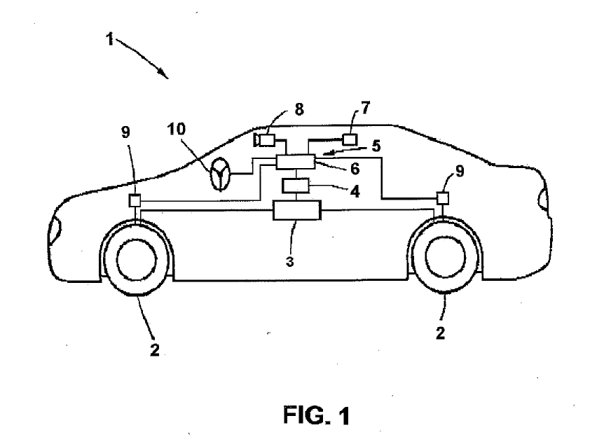

Other features and advantages of the present invention will be more readily apparent upon reading the following description of currently preferred exemplified embodiments of the invention with reference to the accompanying drawing, in which the sole FIG. 1 shows a schematic representation of a motor vehicle according to the invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. in certain instances, details which are not necessary for an understanding of the present invention or which render other details difficult to perceive may have been omitted.

Turning now to the drawing, and in particular to FIG. 1, there is shown a motor vehicle according to the invention including a total of four wheels 2, all of which may be driven. A differential 3 with superimposed transmission is provided at the front axle or the rear axle with associated control device 4. It is also conceivable that each axle has its own differential, i.e. each axle is driven. The differential 3, often referred to as axle drive, is here shown centered for reasons of visibility. In actuality, it is an axle drive which of course is arranged in the respective driven axle, be it the front axle or the rear axle. The differential 3 is an axle differential with superimposed transmission which enables a variable distribution of the drive torques which are provided to the individual wheels via the not further shown drive aggregate which drives the wheels 2.

Further provided is a device 5 for detecting a crosswind offset, which as driver assist system forms a crosswind assistant. Via this system, it is possible to carry out a correction via the differential 3 when detecting a lateral offset which results from crosswind acting on the vehicle.

For this, the device 5 includes a control device 6 which serves for determining a possible lateral offset, and for determining the yaw moment to be generated or to be established via controlling the differential 3.

For detecting the possible lateral offset, the control device communicates in the shown exemplary embodiment with a yaw sensor 7 which detects a possible rotational movement about the vertical axis of the motor vehicle 1. FIG. 1 also shows that a camera 8 communicates with the control device 6. The camera 8 detects the area in front of the vehicle. i.e., it continuously provides images which can be analyzed by the control device 6 for detecting a possible lateral drift. This also allows detecting a possible lateral offset. The yaw rate sensor 7 and the camera 8 can be provided in the alternative but also together to enable a plausibility check of the respectively provided items of information.

Further, the control device 6 communicates with a rotational speed sensor 9, which is assigned to the individual wheels. A lateral offset may result in differences with regard to the rotational speed of the wheels. This alternative or, for the purpose of plausibility, additional analysis can also provide information with regard to a possible lateral offset.

Further, a steering wheel 10 is provided via which the steering angle is set by the driver, i.e. the angle which defines the desired trajectory. The control device 6 communicates with the steering wheel 10 or the angle sensor located there, so that the desired driving lane which the driver desires to drive, which however, due to the acting cross wind is not actually driven or which the vehicle does not follow, is known by the control device 6.

By means of all of these items of information, the control device 6 now determines the own movement, i.e. it determines the actual movement or direction of movement, compares the actual movement or direction of movement with the desired behavior, i.e. the desired driving lane or driving direction which results from the set steering angle, and which the driver actually wishes to follow. When this comparison results in a difference, i.e. a possible lateral offset occurs or is established, the control device immediately determines a corrective yaw moment which is to be generated via the differential 3, i.e. an item of control information relating to how the differential 3 has to distribute the torque for generating a corrective yaw moment. For this, the control device 6 communicates with the control device 4 which in turn controls the differential 3. The differential 3 now immediately changes the torque distribution between the driven wheels, i.e., that the wheel/the wheels of one side are subjected to a greater drive torque than the one/ones of the other side, in order to yaw the vehicle in the opposite direction, i.e. to react to the lane deviation in a correcting manner.

The concrete embodiment can thus be that immediately with the detection of the possible lateral offset the differential performs a base correction, i.e. provides a correcting predetermined yaw moment to one or the other wheel side. Because the control device 6 continuously determines a possible lateral offset, the success can be verified immediately after providing the base yaw moment, i.e. it can be verified how the vehicle behaves as a response to providing the base yaw moment. When the provided corrective base torque is sufficient to correct the lateral offset, no readjustment is performed; when the corrective torque is not sufficient a readjustment is performed by varying the torque distribution.

The corresponding basic adjustment parameters can for example be stored in a suitable tabular form with reference to the concrete actual memory, from which tables the control device 6 then selects the respective required corrective torque in dependence on the concretely detected actual memory. As an alternative this table can also be stored in the control device. The determination of the correcting torque to be stored can occur by a modeling, in that the effect of different correcting torques is modeled by using a corresponding vehicle model in connection with the items of information for the actual storage and as the case may be further parameters, form which then the concretely to be stored corrective torque is selected.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for crosswind stabilization of a motor vehicle, comprising:
detecting a lateral offset of the motor vehicle with a detection device of the motor vehicle;
changing a torque distribution to front and/or rear wheels of the motor vehicle for generating a yaw moment which counteracts the lateral offset, wherein the torque distribution is changed by an actively controllable differential with superimposed transmission for variable torque distribution to both drive sides, said differential driving the wheels.

2. The method of claim 1, wherein the detection device includes a yaw sensor.

3. The method of claim 1, wherein the lateral offset is detected as a function of a rotational speed of the wheels of the motor vehicle.

4. The method of claim 1, wherein the lateral offset, detected by means of a member selected from the group consisting of images recorded with a camera and showing an area in front of the vehicle, radar and laser.

5. The method of claim 1, wherein the lateral offset is continuously detected and wherein the torque distribution is changed as a function of the continuously determined lateral offset.

6. The method of claim 1, wherein the torque distribution is changed to a predetermined torque distribution, and wherein the method further comprises readjusting the predetermined torque distribution.

7. A motor vehicle, comprising:
a device for detecting a lateral offset;
a control unit; and
a differential with variable torque distribution and driving front and/or rear wheels of the motor vehicle, said differential being actively controllable by the control unit to change the torque distribution in response to the lateral offset to thereby generate a yaw moment which counteracts the lateral offset.

8. The motor vehicle of claim 7, wherein the detection device is constructed as a yaw sensor or includes a yaw sensor.

9. The motor vehicle of claim 7, wherein the detection device, is configured to detect the lateral offset by means of a rotational speed of the wheels.

10. The motor vehicle of claim 7, further comprising a camera, which provides images of an area in front of the motor vehicle, wherein the detection device is configured for detecting the lateral offset by analyzing the images.

11. The motor vehicle of claim 7, wherein the detection device is configured to continuously detect the lateral offset, and wherein the control device is configured to continuously change the torque distribution as a function of the continuously detected lateral offset.

12. The motor vehicle of claim 7, wherein the control device is configured to change the torque distribution to a predetermined torque distribution and to readjust the predetermined torque distribution.
